(19) United States
(12) Patent Application Publication
(10) Pub. No.: US 2005/0218120 A1
(43) Pub. Date: Oct. 6, 2005

(54) Energy balanced weld controller

(76) Inventor: Kelvin Shih, Brighton, MI (US)

Correspondence Address: CARLSON, GASKEY & OLDS, P.C., 400 WEST MAPLE ROAD, SUITE 350, BIRMINGHAM, MI, 48009, US

(21) Appl. No.: 11/089,095

(22) Filed: Mar. 24, 2005

Related U.S. Application Data
(60) Provisional application No. 60/559,899, filed on Apr. 6, 2004.

(51) Int. Cl. B23K 11/24

(52) U.S. Cl. 219/110

(57) ABSTRACT

An energy balanced weld controller includes a mid frequency direct current power supply and a weld switch that turns the current to weld caps on or off. The weld caps are used to produce a weld on workpieces. The tip voltage and the weld current are multiplied to generate a voltage which is converted to a frequency. The output represents the amount of energy provided to the weld and is provided to a frequency counter that counts the amount of energy delivered to the weld. A magnitude comparator compares the energy delivered to the weld to a target energy. When the energy delivered to the weld equals the target energy, the magnitude comparator sends a high signal to the weld switch to terminate the weld.

### REFERENCE TO RELATED APPLICATION

This application claims priority to U.S. Provisional Application No. 60/559,899 filed on Apr. 6, 2004.

### BACKGROUND OF THE INVENTION

The present invention relates generally to a closed loop energy balanced weld controller for a resistance welder that measures the energy provided to a weld and stops welding when an amount of energy provided to the weld equals a preset target energy.

Most controllers for resistance welders using alternating current (AC) or mid frequency direct current (MFDC) are either constant voltage (CV) or constant current (CI). Both constant voltage and constant current controllers operate in an open loop configuration.

FIG. 1A illustrates a typical constant voltage controller 100 for a resistance welder. The constant voltage controller 100 includes a low voltage and high current voltage source 105 (Vₛ) that maintains a tip voltage at a constant level. In alternating current welding, Silicon Controlled Rectifiers (SCR) and phase control are used at a primary side of a step down transformer to control the tip voltage. In mid frequency direct current welding, an Isolated Gate Bipolar Transistor (IGBT) and a Pulse Width Modulation (PWM) inverter are used to control the tip voltage at a secondary side of the transformer.

A weld switch 115 turns the voltage to the weld on and off. A weld time command 140 is used to provide a weld time command to a clock and timer 135. When a start switch 110 is pushed, a low power signal starts the weld by closing the weld switch 115. The same lower power signal also starts the clock and timer 135 counting. A large current then flows through an upper weld cap 120 and a lower weld cap 125 of work pieces 130 to be welded. The weld caps 120 and 125 hold the work pieces 130 together with a given force during welding. When the counted time equals the time set by the weld time command 140, the clock and timer 135 sends a stop signal to the weld switch 115 to terminate the weld. The energy delivered to the weld is defined as:

$$E = Energy = {V}_{S} * I * t = {V}_{S} * ( \frac{{V}_{S}}{R} ) * t = \frac{{V}_{S}^{2} * t}{R}$$

V_{S}=Voltage source
I=Current
t=Time
R=Resistance

The constant voltage controller 100 only compensates for changes in the line voltage. However, the constant voltage controller 100 cannot compensate for changes in the resistance of the stack of work pieces 130 caused by anomaly in the stack. The weld time t is constant. If the resistance of the stack is too high, the constant voltage controller 100 will not deliver not enough energy to form an adequately sized nugget. If the resistance of the stack is too low, too much energy is delivered to the weld, and expulsion may occur.

FIG. 1B illustrates a typical constant current controller 145 for a resistance welder. The constant current controller 145 includes a large current and low voltage constant current source 150 (I_{S}) which supplies a weld current to an upper weld cap 160 and a lower weld cap 165. In alternating current welding, Silicone Controller Rectifiers and phase control are used at a primary side of a step down transformer to control a secondary current. In mid frequency direct current welding, an Isolated Gat Bipolar Resistor and a Pulse Width Modulation inverter controls the current at a secondary side of the transformer.

A weld switch 156 turns the current to the weld on and off. A weld time command 180 is used to provide a weld time command to a clock and timer 175. When a start switch 115 is pushed, a low power signal starts the weld by closing the weld switch 156. The same low power signal also starts the clock and timer 175 counting. A large current then flows through the weld caps 160 and 165 and the work pieces 170. When the counted time equals the time set by the weld time command 180, the clock and timer 175 sends a stop signal to the weld switch 156 to terminate the weld. The energy delivery to the weld is defined as:
E=Energy=V_{S}*I*t=(IR)*I*t=I²*R*t

The constant current controller 145 only compensates for changes in the line voltage. However, the constant current controller 145 cannot compensate for changes in the resistance of the stack of workpieces 170 caused by anomaly in the stack. The weld time t is constant. An increase in resistance causes more energy to be delivered to the weld. However, too much energy could cause expulsion and create a bad weld. If the resistance is too low, not enough energy is supplied to the weld, creating an under-sized nugget.

A weld lobe determines the schedules of the weld controllers. The weld lobe is a three-dimensional reference table that uses force, current or voltage and time as the variables. The weld lobe is dependent on the weld gun, the transformer, and the weld caps. The weld lobe is determined by performing many welds when two of the three variables are held constant. The third variable is changed, and the resulting weld nugget size is measured. For example, the force of the weld and the current are kept constant and the time is changed, and many data points are collected. The weld time and the current are then kept constant and the force is changed, and more data points are collected. Another set of data points is generated by keeping the weld time and the force constant and changing the current. The high limit of the weld lobe is expulsion, and the low limit of the weld lobe is an undersized nugget. Expulsion is the eruption of molten metal, which can deteriorate the quality of the nugget. Expulsion can be caused by excessive energy delivered to the nugget or can be caused by a large current density, even if the right amount of energy is delivered to the weld.

A single force, current or voltage and time schedule is then selected to perform the weld. The chosen schedule should be located centrally in the three-dimensional table. If the weld lobe is large enough, a satisfactory weld is formed, even if the chosen schedule is inaccurate. Unfortunately, most of the schedules are too aggressive, and expulsions may result.

A drawback to both constant voltage and constant current weld controllers is that they are open loop systems and cannot accurately control the weld. Therefore, a mediocre or inferior weld quality can result.

Hence, there is a need in the art for an energy balanced weld controller that overcomes the drawbacks and shortcomings of the prior art.

### SUMMARY OF THE INVENTION

An energy balanced weld controller includes a mid frequency direct current power supply that supplies power to a welder and a weld switch that turns the current to weld caps on or off. A Rogowski coil and an integrator measure the secondary weld current provided to the weld, and a pair of tip wires connected to the weld caps detect the tip voltage. A low pass filter filters out all induced noise from the tip voltage.

The filtered tip voltage and the measured weld current are multiplied in a multiplier to generate a voltage that is proportional to the power to the weld. The output of the multiplier is converted to a frequency in a voltage to frequency converter. By properly scaling the system, every pulse from the voltage to frequency converter represents 1 Joule of energy. The output from the voltage to frequency converter is provided to a frequency counter that counts the energy in Joules delivered to the weld. An energy target programmer programs an energy target for each weld.

A magnitude comparator compares the energy delivered to the weld counted by the frequency counter to the energy target. When the energy delivered to the weld equals the energy target, the magnitude comparator sends a high signal to the weld switch to terminate the weld. Another counter displays the weld time, so cap wear information can be calculated and proper action can be taken to compensate for it.

The energy balanced weld controller can also include a fault tolerant system that terminates the weld after a preprogrammed maximum weld time is reached in case the Rogowski coil fails or a tip wire breaks. This feature is extremely important in the automotive industry. When the Rogowski coil fails or the tip wire breaks, the repair can be performed at a shift change or during a brake, and the production line does not need to be stopped to fix the problem.

The energy balance weld controller can also include a weld cap wear compensation and nugget estimation system that compensates for wear of the weld caps over time and estimates a size of the nugget using a central processor unit.

The present invention relates generally to a closed loop energy balanced weld controller for a resistance welder that measures the energy provided to a weld and terminates welding when the measured energy equals the target energy.

Further features and advantages of the invention will become clearer from the detailed description that follows of some embodiments of the invention given solely by way of example and with reference to the attached drawings.

### BRIEF DESCRIPTION OF THE DRAWINGS

FIG. 1A is a block diagram of a constant voltage weld controller of the prior art;

FIG. 1B is a block diagram of a constant current weld controller of the prior art;

FIG. 2 is a system diagram of an energy balanced weld system of the present invention;

FIG. 3 is a block diagram of a Mid Frequency Direct Current power supply used with the energy balanced weld system;

FIG. 4 is a block diagram of the energy balanced weld controller implemented with part analog circuit and part digital logic circuit;

FIG. 5 is a block diagram of the energy balanced weld controller implemented with a Programmable Logic Device;

FIG. 6 is a block diagram of the energy balanced weld controller implemented with all analog circuits;

FIG. 7 is a block diagram of the energy balanced weld controller using a microprocessor for both the signal processing and the control logic;

FIG. 8 is the block diagram of a fault tolerant energy balanced weld controller; and

FIG. 9 is a block diagram showing a system for weld cap wear compensation and nugget size estimation used with the energy balanced weld controller.

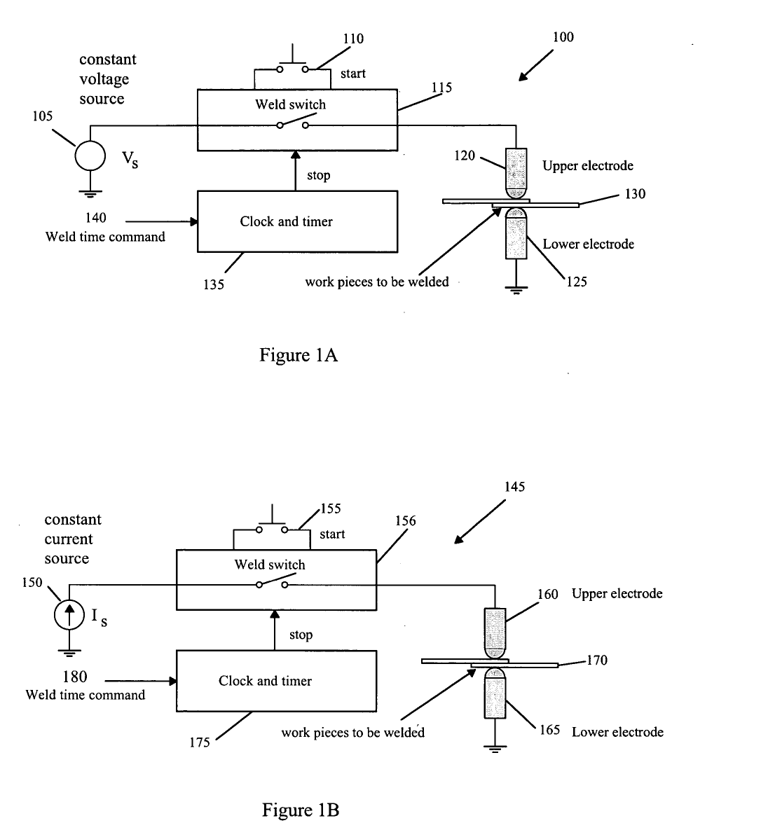

### DETAILED DESCRIPTION OF THE PREFERRED EMBODIMENT

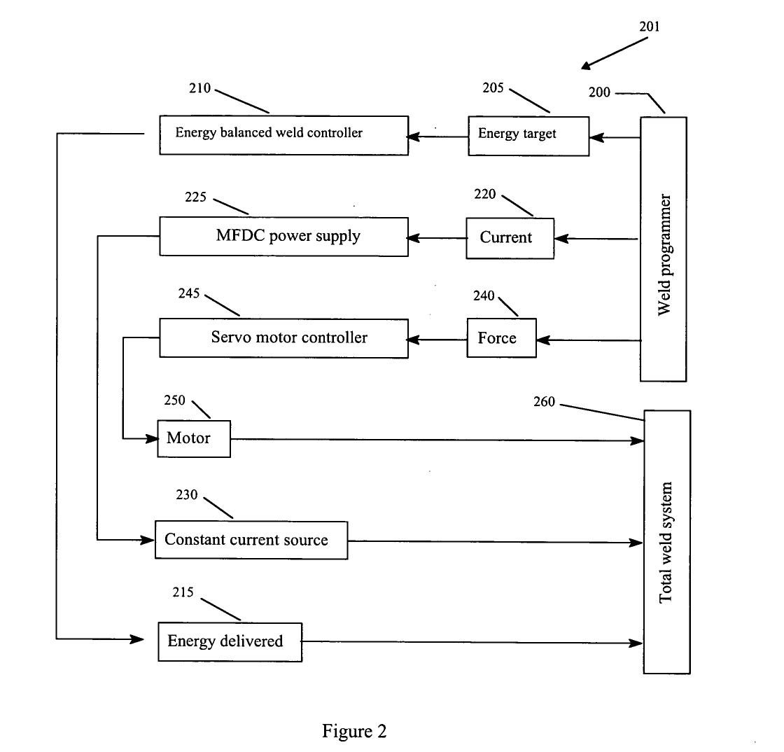

FIG. 2 illustrates a system diagram of an energy balanced weld system 201 of the present invention. A weld programmer 200 supplies a programmed energy target command 205, a programmed current command 220 and a programmed force command 240. The programmed energy target command 205 includes four-digit binary coded digital (BCD) or DC voltage (in all analog implementation) energy target information that is supplied to an energy balanced weld controller 210. The energy balanced weld controller 210 delivers an exact amount of the energy 215 to a total weld system 260. The programmed current command 220 is provided to a mid frequency direct current power supply 225 to control the Isolated Gate Bipolar Transistors and to provide a constant weld current 230 to the total weld system 260. The current control signal can either be a voltage or a digital coded signal. The programmed force command 240 is provided to a servomotor controller 245 which controls the direction, the speed, and the torque of a motor 250 that controls the clamp force of the weld system 260.

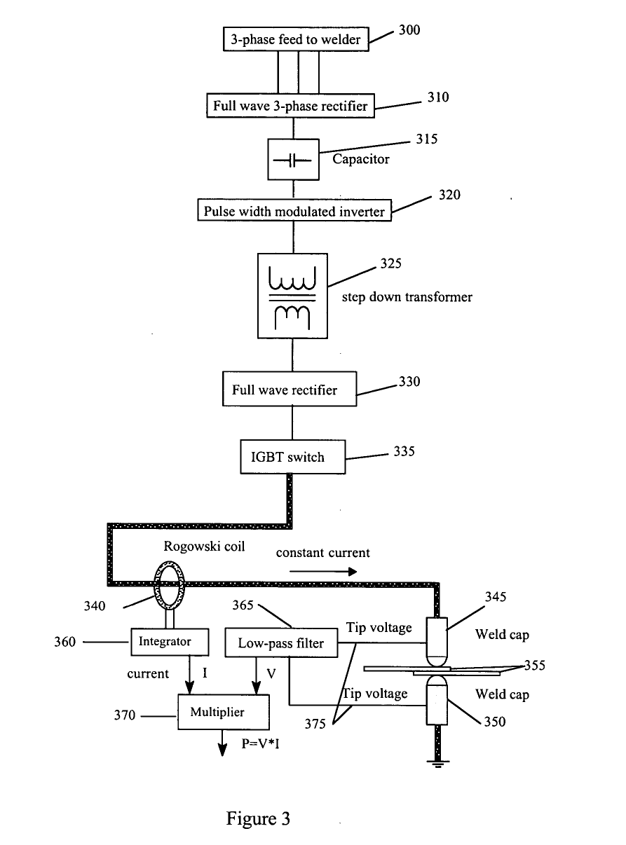

FIG. 3 illustrates a Mid Frequency Direct Current power supply used in a welding application. A three-phase feed 300 is connected to a water-cooled three-phase full wave rectifier 310. An output from the three-phase full wave rectifier 310 is then used to charge a large high voltage capacitor 315. The direct current voltage passes through a pulse width modulated inverter 320 and is converted to a mid frequency signal. The pulse width modulated inverter 320 changes the voltage from direct current to alternating current and controls the weld current at a secondary side of a transformer 325 to keep current constant. A primary side of the transformer 325 has a high voltage and low current, and a secondary side of the transformer 325 has a low voltage and very high current. A full wave rectifier 330 rectifies the output from the transformer 325 secondary to the direct current.

An Isolated Gate Bipolar Transistor switch 335 controls the on/off of the current provided to the weld. Once welding begins, a Rogowski coil 340 and an integrator 360 integrate the output of the Rogowski coil 340 to provide a voltage that represents the weld current. The weld current flows through weld caps 345 and 350 and work pieces 355 to produce a weld. Two tip wires 375 connected to the weld caps 345 and 350 measures the tip voltage. A low pass filter 365 then filters out all the induced noise in the tip voltage signal.

Power is defined as voltage multiplied by current. A multiplier 370 multiplies the measured current and the measured tip voltage to produce a voltage that represents power. Energy equals the integral of power with respect to time. Energy delivered can then be calculated by integrating the power signal through the duration of the weld.

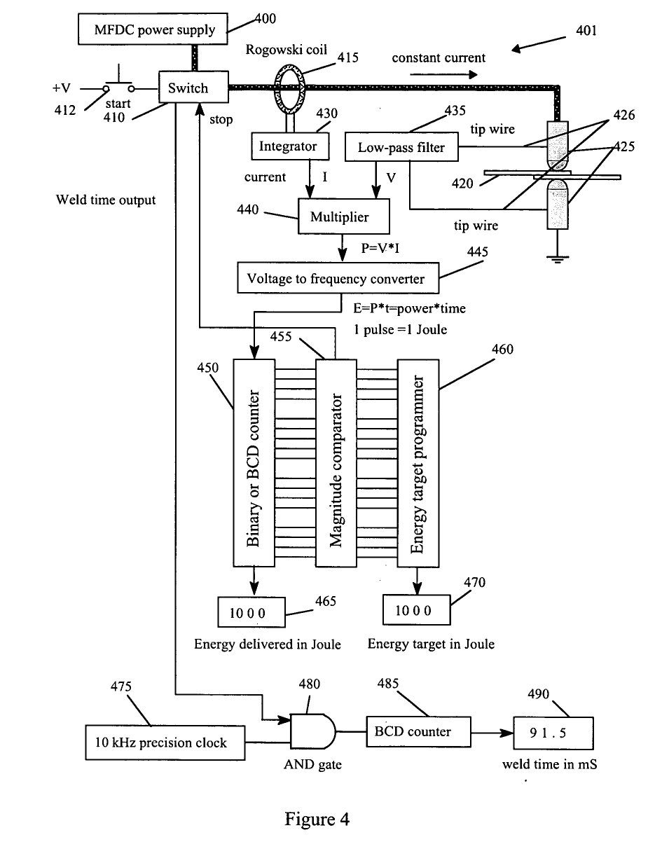

FIG. 4 illustrates a block diagram of an energy balanced weld controller 401 implemented with partly analog circuits and partly digital circuits. A mid frequency direct current power supply 400 supplies power to a welder. A weld switch 410 turns the current to weld caps 425 on or off. A Rogowski coil 415 is an air core toroidal transformer that is used to measure the weld current. An output voltage of the Rogowski coil 415 is provided to an integrator 430 to produce a voltage that represents the weld current, which is defined as:

$${V}_{R} = - M \frac{ⅆ i}{ⅆ t}$$

$$i = - \frac{1}{M} {\int }_{0}^{t} {V}_{R} ⅆ t$$

V_{R}=Rogowski output voltage
M=mutual inductance between the weld current and the Rogowski coil
t=weld time
i=instantaneous current

The integrator 430 includes operational amplifiers, resistors and capacitors. A solid-state switch discharges the capacitor just before welding begins to eliminate the error caused by offset voltage of the operational amplifier. A pair of tip-wires 426 connected to the weld caps 425 sense the tip voltage of the weld. A low pass filter 435 removes any induced noise in the tip voltage coming from the tip wires 426. The current signal from the Rogowski coil integrator 430 and the tip voltage signal from the low pass filter 435 are multiplied in an analog multiplier 440 to generate a voltage that is proportional to the power. The output of the analog multiplier 440 is scaled such that 10,000 watts equals 1 volt.

The output from the analog multiplier 440 is sent to a voltage to frequency converter 445, which converts the voltage that represents the power to a frequency such that 1 volt equals 10,000 Hz. This makes each pulse from the voltage to frequency converter 445 representing 1 Joule of energy. The output of the voltage to frequency converter 445 is provided to a binary or binary coded decimal (BCD) frequency counter 450, which counts the energy delivered to the weld in Joules. A LED or LCD display 465 displays the energy provided to the frequency counter 450.

An energy target for the weld is programmed in an energy target programmer 460, which can be either binary or binary coded decimal depending on the frequency counter 450. Another LED or LCD display 470 displays the target energy set by the energy target programmer 460. However, both displays 465 and 470 are optional in production machine.

A magnitude comparator 455 compares the energy delivered to the weld as counted by the frequency counter 450 to the energy target programmed into the energy target programmer 460. When the energy delivered to the weld equals the energy target, the magnitude comparator 455 sends a high signal to the weld switch 410 to terminate the weld.

A crystal controlled precision clock 475 supplies a 10 kHz frequency to one input of an AND gate 480. The weld switch 410 supplies the other input to the AND gate 480. The output of the AND gate 480 is sent to a binary coded display counter 485 and is displayed on a LED or LCD display 490 in ms. The AND gate 480 is controlled by the weld switch 410, and the 10 kHz pulses only reach the counter 485 during welding, enabling the weld time to be measured to a resolution and accuracy of 100 μs.

For example, work pieces 420 made of two sheets of mild steel each having a thickness of 0.71 mm are welded together with 300 lbs force. When the start button 412 is pushed to begin the weld, the weld switch 410 is closed and 9000 A of current flows through the weld caps 425 and the work pieces 420. A target energy of 1000 Joules is programmed into the energy target programmer 460. The Rogowski coil 415 and the integrator 430 measures the current, and the tip wires 426 measures the tip voltage which is then filtered by the low-pass filter 435. The tip voltage and the current are multiplied in the analog multiplier 440 to calculate a power P. The voltage representing power P is sent to the voltage to frequency converter 445 to generate a pulse stream having a frequency proportional to the power. A frequency counter 450 counts the energy in Joules delivered to the weld. When the energy counted by the frequency counter 450 reaches the energy target of 1,000 Joules programmed into the energy target programmer 460, the magnitude comparator 455 sends a high signal to the weld switch 410 to terminate the weld. Both the energy delivered display 465 and the energy target display 470 display 1,000 Joules, and the weld time display 490 will display the weld time.

The energy balanced weld controller 401 produces a large nugget while eliminating almost all the expulsions. Before welding begins, the force, the current and the target energy are selected and programmed. The target energy is set at a minimum value to conserve energy usage, as well as eliminate expulsions. The energy balanced weld controller 401 uses constant current and the energy target to perform all the welds.

By using the Rogowski coil 415 and the tip wires 426 for feedback, the energy balanced weld controller 401 setting is independent of the configuration of the weld gun. Therefore, any experimental results performed on an experimental weld gun can be used on any weld gun, provided the same types of weld caps are used. Therefore, a weld lobe study for a specific type of weld or a certain type of weld gun is not necessary. Mid frequency direct current (MFDC) is used as the power supply, enabling the energy balanced weld controller 401 to terminate the weld at anytime without completing an entire alternating current cycle. Therefore, exceptional resolution and repeatability is possible. The life of weld caps 425 using the energy balanced weld controller 401 is also many times greater than the prior art alternating current weld controller and other MFDC controllers using the traditional current and time method.

A typical automobile includes an average of 4,000 welds that hold the automobile together. Because the weld energy is limited during welding, the weld material between the caps is softened and not melted. The weld usually indents less than 15%, as compared to the 30-50% indentation using the controllers of the prior art. The energy balanced weld controller 401 uses less than 25% of the energy than the prior art alternating current weld controller uses and uses less than 50% of the energy than the prior art mid frequency direct current (MFDC) weld controller uses.

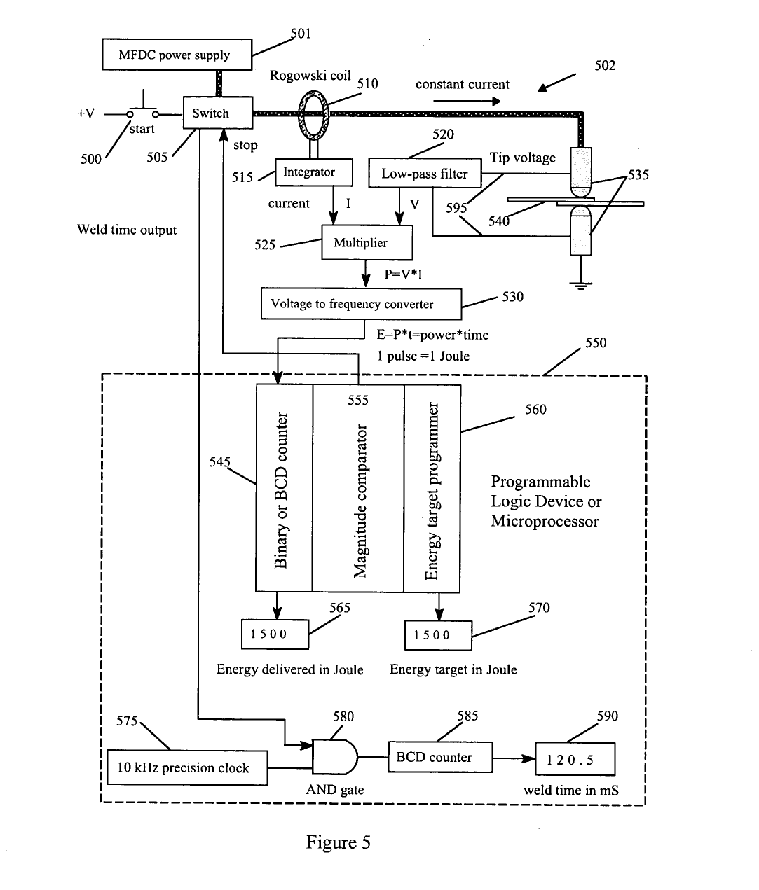

FIG. 5 shows an energy balanced weld controller 502 similar to FIG. 4, except that the logic circuits have been replaced by a programmable logic device (PLD) 550 for simplicity. A mid frequency direct current (MFDC) power supply 501 supplies power to the welder. When a start switch 500 is actuated to begin a weld, a weld switch 505 turns on to let current flow through weld caps 535 and work pieces 540 to produce a weld. A Rogowski coil 510 with an integrator 515 measures the current. Tip wires 595 measure the tip voltage which passes through a low pass filter 520 that removes all induced noise. An analog multiplier 525 multiplies the filtered tip voltage and the weld current signals to obtain a voltage that is proportional to the power. The output of the analog multiplier 525 is scaled such that 10,000 Watts equals 1 volt.

The output of the analog multiplier 525 is sent to a voltage to a frequency converter 530, which converts the voltage to frequency such that 1 volt equals 10,000 Hz. This makes one pulse from the voltage to frequency converter 530 equal to 1 Joule.

This signal from the voltage to frequency converter 530 is sent to the programmable logic device or microprocessor 550 to count the energy delivered to the weld and to compare the counted energy to an energy target. A binary or binary coded decimal counter 545 counts the energy delivered to the weld, and a LED or LCD display 565 displays the energy delivered to the weld in Joules. An energy target for the weld is programmed in an energy target programmer 560, which can be either binary or binary coded decimal depending on the frequency counter 545. Another LED or LCD display 570 displays the target energy setting programmed in the energy target programmer 560. However, both displays 565 and 570 are optional in a production machine.

A magnitude comparator 555 compares the energy delivered to weld as counted by the frequency counter 545 to the energy target programmed into the energy target programmer 560. When the energy delivered equals the energy target, the magnitude comparator 555 sends a high signal to the weld switch 505 to terminate the weld.

A crystal controlled precision clock 575 supplies a 10 kHz frequency to one of two inputs of an AND gate 580. The weld switch 505 supplies the other input to the AND gate 580. The output of the AND gate 580 is sent to a binary coded display counter 585 and is displayed on a LED or LCD display 590 in ms. The AND gate 580 is controlled by the weld switch 505, and the 10 kHz pulses only reach the counter 585 during welding, enabling the weld time to be measured to a resolution and accuracy of 100 μs.

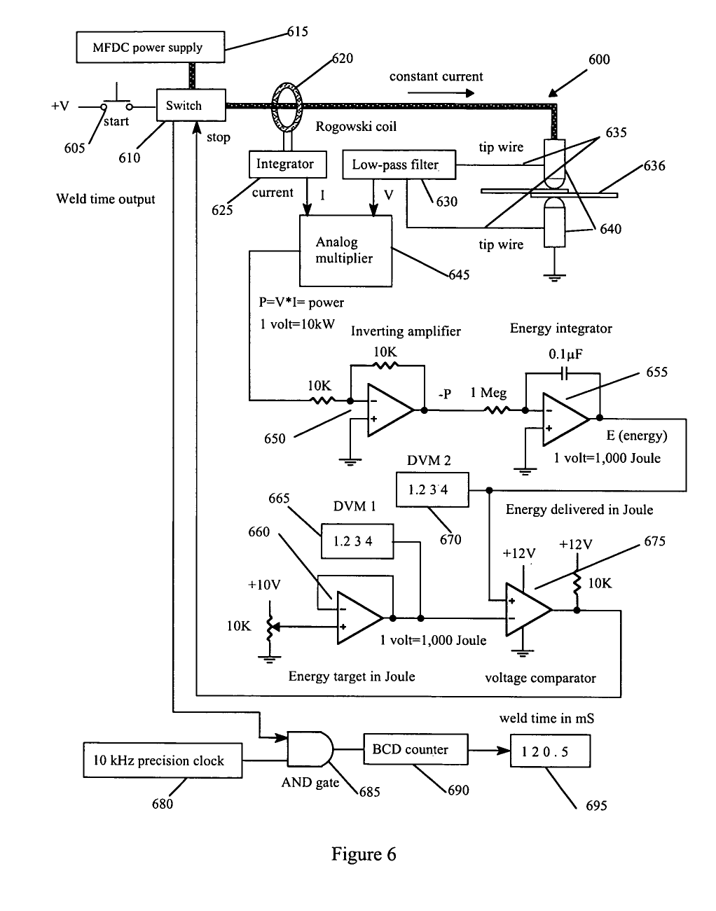

FIG. 6 illustrates an energy balanced weld controller 600 implemented with all analog circuits. Instead of digital codes, the energy target is set with a voltage. A 10K potentiometer buffered by a voltage follower circuit 660 supplies a voltage that represents the energy target. The output of the voltage follower circuit 660 is scaled such that 1 volt equals 1,000 Joules. A display 665 displays the pre-determined energy target in Joules. The display 665 is a digital voltmeter (DVM) and can be either a LCD or a LED type.

A mid frequency direct current (MFDC) power supply 615 supplies power to the welder. When a start switch 605 is pushed, a weld switch 610 turns on and a pre-determined amount of current flows through weld caps 640 and work pieces 636 to produce a weld. A Rogowski coil 620 and an integrator 625 measure the current, and a tip voltage sensed by tip wires 635 passes through a low pass filter 520 to remove all induced noises. The filtered voltage and the current are multiplied in an analog multiplier 645 to generate a voltage that is proportional to power. The output of the analog multiplier 645 is scaled such that 10,000 watts equals 1 volt.

The output of the multiplier 645 is sent to an inverting amplifier 650 to change the polarity. The signal is then sent to an energy integrator 655. The signal is inverted in the inverting amplifier 650 because the energy integrator 655 needs a negative voltage to generate a positive voltage that represents energy. For example, if the power delivered to the weld is 10,000 watts, then the following equation is used to calculate the voltage.

$$E = energy = - \frac{1}{( 1 Meg ) * ( 0.1 μ F )} {\int }_{0}^{1} ( - 1 ) ⅆ t = 10 volts$$

Therefore, a 10,000 watt power source will deliver 1 volt, or 1,000 Joules of energy, in one tenth of a second. A display 670 displays the energy delivered to the weld. In one example, the display 670 is a digital voltmeter (DVM) and can be with a LCD or LED type.

As welding continues, the output voltage of the energy integrator 655 increases. A voltage comparator 675 compares the energy output of the energy integrator 655 with the energy target programmed into the voltage follower circuit 660. When the energy delivered to the weld equals the pre-determined energy target, the voltage comparator 675 sends a high signal to the weld switch 610 to terminate the weld.

A crystal controlled precision clock 680 supplies a 10 kHz frequency to one of two inputs of an AND gate 685. The weld switch 610 supplies the other input to the AND gate 685. The output of the AND gate 685 is sent to a binary coded display counter 690 and is displayed on a LED or LCD display 695 in ms. The AND gate 685 is controlled by the weld switch 610, and the 10 kHz pulses only reach the counter 690 during welding, enabling the weld time to be measured to a resolution and accuracy of 100 μs.

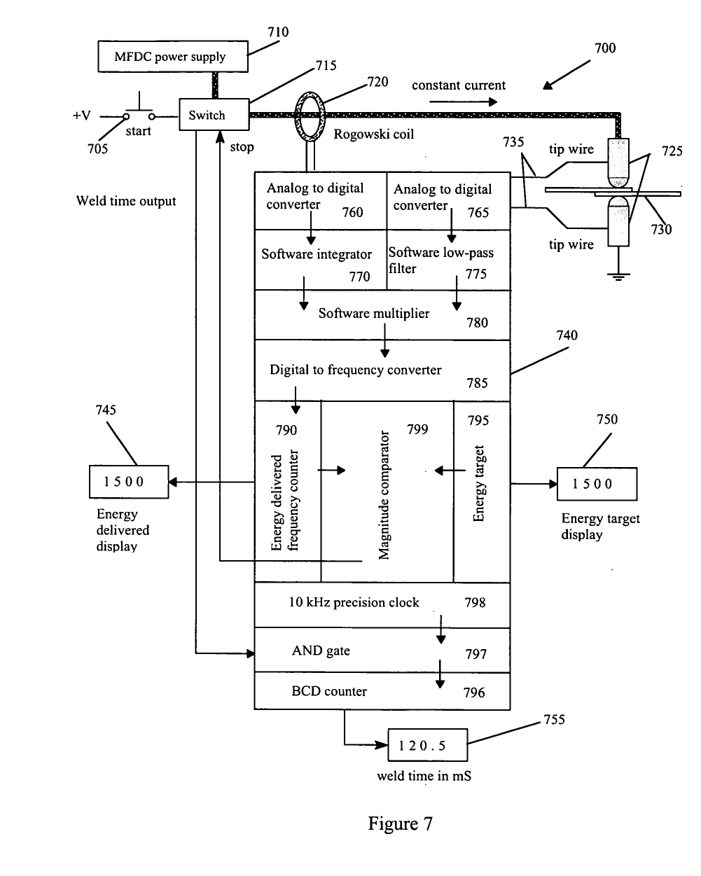

FIG. 7 is a block diagram of the energy balanced weld controller 700 implemented with a microprocessor 740. A mid frequency direct current (MFDC) power supply 710 supplies power to the welder. When a start switch 705 is pushed, a weld switch 715 closes and welding begins. When the weld switch 715 closes, weld current is delivered to work pieces 730 through weld caps 725. A Rogowski coil 720 measures the current supplied to the weld and directly provides an output to an analog to digital converter (ADC) 760 inside the microprocessor 740. Tip wires 735 are also connected to an analog to digital converter (ADC) 765 inside the microprocessor 740 to measure the tip voltage. The analog to digital converters 760 and 765 convert both the raw current signal and the raw voltage signal, respectively, to a pair of digital signals inside the microprocessor 740.

The converted current signal passes through a software integrator 770, and a software low-pass filter 775 filters the converted voltage signal. The voltage signal and the current signal are then multiplied digitally in a software multiplier 780. The output from the software multiplier 780 is then converted to a frequency in a digital to frequency converter 785.

An energy delivered frequency counter 790 counts the pulses from the digital to frequency converter 785 that represent the energy delivered to the weld. An energy target 795 is programmed into the microprocessor 740. A magnitude comparator 799 counts and compares the Joules of energy delivered to the weld as counted by the frequency counter 790 to the energy target 795 programmed in the microprocessor 740. When the energy delivered to the weld equals the target energy, the microprocessor 740 sends a high signal to the weld switch 715 to terminate the weld. Information about the energy delivered and the target energy can be outputted through output ports and displayed on displays 745 and 750, respectively.

A crystal controlled precision clock 798 inside the microprocessor 740 supplies a 10 kHz frequency to an input of an AND gate 797. The weld switch 715 supplies the other input to the AND gate 797. The output of the AND gate 797 is provided to a binary coded display counter 796 and is displayed on a LED or LCD display 755 in ms. The AND gate 797 is controlled by the weld switch 715, and the 10 kHz pulses only reach the counter 796 during welding, enabling the weld time to be measured to a resolution and accuracy of 100 μs.

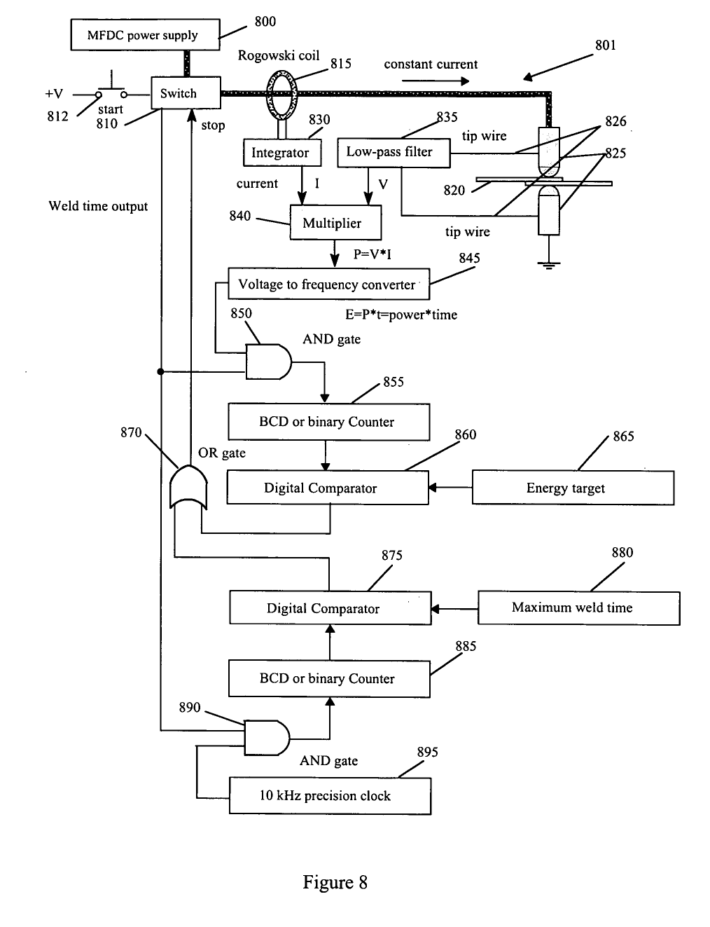

FIG. 8 is a block diagram of a fault tolerant energy balanced weld controller 801. A mid frequency direct current (MFDC) power supply 800 provides the weld current. A weld switch 810 controls the on/off of the current, and a start switch 812 begins the weld. A Rogowski coil 815 and an integrator 830 provides the current signal, and tip wires 826 are connected to weld caps 825 to measure the tip voltage.

If a tip wire 826 breaks or the Rogowski coil 815 fails, the feedback loop is broken. Without a fault tolerant protection system, welding will continue until the weld caps 825 burn a hole through metal work pieces 820. The energy balanced weld controller 801 includes a fault tolerant control system to prevent this from occurring.

A low pass filter 835 filters the tip voltage. The filtered tip voltage and the current measured from the Rogowski coil 815 and the integrator 830 are multiplied in a multiplier 840, and the output is then sent to a voltage to frequency converter 845. The output from the voltage to frequency converter 845 represents the power feed into the weld.

The frequency from the voltage to frequency converter 845 is sent to an input of an AND gate 850 and is then sent to a binary coded decimal or binary counter 855. The output of the counter 855 is sent to a digital comparator 860 and compared to an energy target 865. When the output of the counter 855 equals the energy target 865, the digital comparator 860 issues a command through an OR gate 870 to the weld switch 810 to terminate the weld.

A 10 kHz precision clock 895 sends one of two inputs to an AND gate 890. The other input to the AND gate 890 is controlled by the on/off signal provided by the weld switch 810. When the start switch 812 is actuated, the weld switch 810 turns on. The weld switch 810 sends a high signal to one of the inputs of the AND gate 890 and allows the 10 kHz pulse train from the precision clock 895 to pass through the AND gate 890.

The output of the second AND gate 890 is sent to a binary coded decimal or binary counter 885. The counter 885 provides one of two inputs of a second digital comparator 875. The other input to the second digital comparator 875 is provided by a maximum weld time switch 880. A maximum weld time is programmed into the maximum weld time switch 880 which is higher than the normal weld time of welding.

The maximum weld time 880 is set so that that under normal weld conditions, the target energy will be reached first and terminate the weld. If either the Rogowski coil 815 failed or the tip wire 826 is broken, the feedback loop will no longer be able to terminate the weld. At this time, the counter 885 will count until the count equals the maximum weld time 880. The comparator 875 will then terminate the weld.

For example, during normal welding with the energy target set at 1000 Joules, the weld time usually does not exceed 85 ms. The maximum weld time can then be set at 100 ms. During a normal weld cycle, the energy target is reached first, and the first digital comparator 860 sends a high signal through the OR gate 870 to the weld switch 810 to terminate the weld. However, if a tip wire 826 breaks or the Rogowski coil 815 fails, the feedback loop does not exist and there will be no output at the voltage to frequency converter 845. The weld will not end because the energy target 865 will never be reached.

In this case, when the counter 885 reaches the maximum weld time, the digital comparator 875 issues a high signal to the weld switch 810 through the OR gate 870 to terminate the weld. The welding will therefore end at 100 ms. When this occurs, the weld controller will still produce a good weld, but the tight control loop is broken and repeatability of the weld is lost. The welder will also use more energy for the same weld. A warning signal will be generated to alert the operator that either a tip wire 826 is broken or the Rogowski coil 815 has failed. The operators do not need to stop the line to fix this problem, and the problems can be fixed during a shift change or at the same time when the weld caps 825 are replaced.

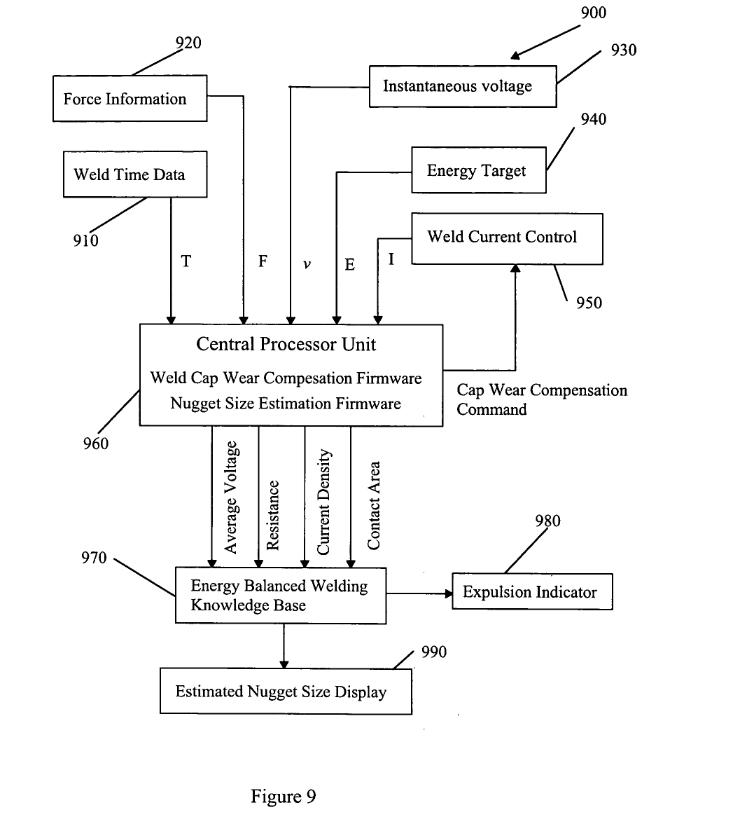

The maximum weld time 880 is always programmed slightly higher than the actual weld time. Because the maximum weld time 880 is greater than the normal weld time, the energy target 865 will be reach first during normal welding and terminate the weld. The counter 885 reading records accurate weld time information for weld cap wear compensation and nugget size monitoring. The energy balanced weld controller 801 can measure the weld time to provide information about weld cap 825 wear compensation and estimate the nugget size before welding begins, as described with reference to FIG. 9. The weld time information can be collected and processed for every weld. When constant current and weld time are desired, the energy target is set higher than normal. This allows information about the amount of energy delivered to be collected at a certain current and time period.

FIG. 9 illustrates a block diagram showing a weld cap wear compensation and nugget size estimation system 900. The system 900 includes four inputs and a central processor unit (CPU) 960. An operator programs information about an energy target 940 (E) and a weld current (I), which are both constants. The weld current is programmed into a weld current control 950. The instantaneous voltage 930 (v) is measured and provided to the central processor unit 960 to detect expulsion. The weld time 910 (T) is measured during the weld. A fifth input can provides force information 920, however this is optional. Using these values, the average voltage can be calculated:

$${V}_{AVG} = \frac{E}{I * T}$$

The resistance of the weld is calculated using the following equation:

$$R = \frac{{V}_{AVG}}{I}$$

$$R = ρ \frac{d}{A} = \frac{{k}_{1}}{A}$$

A=K₁R
R=resistance of the weld
ρ=resistivity of the metal, a constant
d=total thickness of the metal, close to be a constant
A=contact area between the two electrodes and the metal, a function of force cap size and type of cap
k₁=constant

The current density can be calculated using the following equation:

$$Current density = δ = \frac{I}{A} = \frac{{V}_{AVG}}{R * A} = \frac{{V}_{AVG}}{\frac{{k}_{1}}{A} * A} = \frac{{V}_{AVG}}{{k}_{1}}$$

Over thousands of welds, the surface area of the weld caps increases, increasing the contact area A between the weld caps and decreasing the current density □ and the average voltage V_{AVG}. The target energy of the weld stays the same, and therefore the weld time t increases as the weld caps wear. The energy balanced weld controller includes a built-in clock in the weld time data collector 910 that measures the weld time t. As the weld time increases by 5%, a voltage signal is sent from the central processor unit 960 to the weld current control 950 to increase the weld current by 5%. This will maintain the current density □ and the average voltage V_{AVG} at a constant value and reduce the weld time t. The new reduced weld time is remembered in the central processor unit 960. When the weld time t again increases by 5%, the process is repeated. This will ensure that a nugget is generated that has the same size as before. This is how the energy balanced weld controller compensates for wear of the weld caps. The weld caps can be changed during a shift change and the line does not need to be shut down.

Additionally, the central processor unit 960 can calculate any relevant information about the weld and store this information in an energy balanced welding knowledge base 970 so that the nugget size can be estimated with increasing certainty. The average voltage V_{AVG}, resistance R, current density □ and contact area A can all be calculated in the central processor unit 960 from a single weld time measurement using the above equations.

Once the knowledge base 970 is large enough for a certain type of weld cap, the nugget diameter can be easily estimated. The estimated nugget size can be displayed on an estimated nugget size diameter display 990.

When expulsion occurs, the instantaneous voltage ν 930 drops as a step function to a lower level. This sudden change can be easily detected either with an analog or digital circuit located in the central processor unit 960. A firmware program can also be used to detect the expulsion. The occurrence of an expulsion can be indicated on an expulsion indicator 980.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

1. An energy balanced weld controller comprising:
a power supply to supply a current to a weld; and
a magnitude comparator that compares an amount of energy provided to the weld to a target energy and sends a signal to stop the current from being supplied to the weld supply when the amount of energy provided to the weld equals the target energy.

2. The energy balanced weld controller as recited in claim 1 wherein the power supply is a mid frequency direct current power supply.

3. The energy balanced weld controller as recited in claim 1 further including a weld switch that controls the current to the weld, and the magnitude comparator sends the signal to the weld switch to stop the current from being supplied to the weld.

4. The energy balanced weld controller as recited in claim 1 further including a current sensor that senses the current supplied to the weld and a voltage sensor that senses voltage of the weld.

5. The energy balanced weld controller as recited in claim 4 wherein the current sensor is a Rogowski coil.

6. The energy balanced weld controller as recited in claim 4 wherein the voltage sensor is a tip wire connected to a weld cap.

7. The energy balanced weld controller as recited in claim 4 further including a low pass filter that filters the voltage sensed by the voltage sensor.

8. The energy balanced weld controller as recited in claim 4 further including a multiplier that multiplies the current sensed by the current sensor and the voltage sensed by the voltage sensor to provide a power.

9. The energy balanced weld controller as recited in claim 8 further including a voltage to frequency converts that converts the power to a frequency that represents the amount of energy provided to the weld.

10. The energy balanced weld controller as recited in claim 1 further including an energy counter that counts the amount of energy provided to the weld.

11. The energy balanced weld controller as recited in claim 1 further including an energy display that displays the amount of energy provided to the weld.

12. The energy balanced weld controller as recited in claim 1 further including a target energy display that displays the target energy.

13. The energy balanced weld controller as recited in claim 1 further including a weld time counter that counts weld time.

14. The energy balanced weld controller as recited in claim 13 further including a display that displays the weld time.

15. The energy balanced weld controller as recited in 13 wherein the power supply increases the current provided to the weld to a predetermined amount when the weld time counter counts that that the weld time exceeds a threshold time.

16. The energy balanced weld controller as recited in claim 1 further including:
a maximum time controller, and a maximum weld time is programmed into the maximum time controller that is higher than an average weld time; and
a weld switch that controls the current to the weld, wherein the maximum time controller sends a signal to the weld switch to stop the current from being supplied to the weld when a weld time equals the maximum weld time.

17. An energy balanced weld controller comprising:
a power supply to supply current to a weld;
a weld switch that controls the current to the weld;
a current sensor that senses the current supplied to the weld;
a voltage sensor that senses voltage of the weld;
a multiplier that multiplies the current sensed by the current sensor and the voltage sensed by the voltage sensor to provide a power;
a voltage to frequency converter that converts the power to a frequency that represents the amount of energy provided to the weld; and
a magnitude comparator that compares the amount of energy provided to the weld to the target energy and sends a signal to the weld switch to stop the current from being supplied to the weld when the amount of energy provided to the weld equals the target energy.

18. The energy balanced weld controller as recited in claim 17 wherein the power supply is a mid frequency direct current power supply.

19. The energy balanced weld controller as recited in claim 17 wherein the current sensor is a Rogowski coil.

20. The energy balanced weld controller as recited in claim 17 wherein the voltage sensor is a tip wire connected to a weld cap.

21. The energy balanced weld controller as recited in claim 17 further including a low pass filter that filters the voltage sensed by the voltage sensor.

22. The energy balanced weld controller as recited in claim 17 further including an energy counter that counts the amount of energy provided to the weld.

23. The energy balanced weld controller as recited in claim 17 further including an energy display that displays the amount of energy provided to the weld.

24. The energy balanced weld controller as recited in claim 17 further including a target energy display that displays the target energy.

25. The energy balanced weld controller as recited in claim 17 further including weld a time counter that counts weld time.

26. The energy balanced weld controller as recited in claim 25 further including a display that displays the weld time.

27. The energy balanced weld controller as recited in 25 wherein the power supply increases the current provided to the weld to a predetermined amount when the weld time counter counts that that the weld time exceeds a threshold time.

28. The energy balanced weld controller as recited in claim 17 further including a maximum time controller, and a maximum weld time is programmed into the maximum time controller that is higher than an average weld time, wherein the maximum time switch sends a signal to the weld controller to stop the current from being supplied to the weld when a weld time equals the maximum weld time.

29. A method of welding comprising the steps of:
detecting an amount of energy provided to a weld; and
stopping a current flow to the weld when the amount of energy provided to the weld equals a target energy.
